(19) United States
(12) Patent Application Publication
(10) Pub. No.: US 2026/0094892 A1
(43) Pub. Date: Apr. 2, 2026

(54) STEEL PRISMATIC BATTERY WITH ANISOTROPIC THERMAL CONDUCTIVITY MATERIALS

(71) Applicant: GM Global Technology Operations LLC, Detroit, MI (US)

(72) Inventors: Xiaoling Chen, Sterling Heights, MI (US); Diptak Bhattacharya, Royal Oak, MI (US); William Yu Chen, Troy, MI (US); Ryan Patrick Hickey, Austin, TX (US); Matthew Arthur Celentano, Berkley, MI (US); Derek Frei Lahr, Ann Arbor, MI (US)

(73) Assignee: GM Global Technology Operations LLC, Detroit, MI (US)

(21) Appl. No.: 18/901,694

(22) Filed: Sep. 30, 2024

(51) Int. Cl. H01M 10/653; H01M 10/613; H01M 10/625; H01M 10/647; H01M 50/119; H01M 50/121; H01M 50/124

(52) U.S. Cl. CPC H01M 10/653; H01M 10/613; H01M 10/625; H01M 10/647; H01M 50/119; H01M 50/121; H01M 50/124; H01M 2220/20

(57) ABSTRACT

A prismatic battery assembly includes a cell, a heat dissipating element, and a layer of anisotropic material. The cell includes an enclosure having a first end, a second end, a side wall extending between the first end and the second end, and a terminal disposed at the first end. The heat dissipating element extends along the second end. The layer of anisotropic material extends in a direction parallel to the side wall and has a first level of thermal conductivity in the direction parallel to the side wall and a second level of thermal conductivity in a direction transverse to the side wall. The first level of thermal conductivity is greater than the second level of thermal conductivity. Heat generated within the enclosure of the cell is dissipated along the layer of anisotropic material in the direction parallel to the side wall and into the heat dissipating element.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure generally relates to rechargeable batteries having a plurality of cells, such as prismatic batteries or cylindrical batteries. Typically, the plurality of cells in a rechargeable battery are arranged adjacent to one another. As the battery is operated (e.g., during charging of the battery or during discharging of the battery), the cells generate heat within the battery assembly and may transfer heat between the adjacent cells. As the temperature of the cells increases, it may result in decreased efficiency and performance of the prismatic battery. Furthermore, during a thermal runaway event at one cell, heat transfer may cause thermal runaway at other cells within the battery.

The cells within the prismatic battery generally include casings made of aluminum. Aluminum offers a relatively high thermal conductivity, such as for transferring heat from the battery cells to heat dissipating elements. Aluminum casings are generally suitable for lithium-based battery cells, as temperatures experienced during thermal runaway events typically do not exceed the melting point of the aluminum casings. In other words, aluminum casings may be sufficient to maintain structural integrity of the battery casings during thermal runaway events for lithium-based batteries. However, batteries with higher energy densities, such as nickel-based batteries, experience higher temperatures during thermal runaway events, and aluminum cell casings included in nickel-based batteries may experience catastrophic failure such as side-wall rupture.

### SUMMARY

One aspect of the disclosure provides a prismatic battery assembly. The prismatic battery assembly includes a cell, a heat dissipating element, and a layer of anisotropic material. The cell includes an enclosure having a first end, a second end, a side wall extending between the first end and the second end, and a terminal disposed at the first end. The heat dissipating element extends along the second end. The layer of anisotropic material extends in a direction parallel to the side wall and has a first level of thermal conductivity in the direction parallel to the side wall and a second level of thermal conductivity in a direction transverse to the side wall. The first level of thermal conductivity is greater than the second level of thermal conductivity. During operation of the prismatic battery assembly, heat generated within the enclosure of the cell is dissipated along the layer of anisotropic material in the direction parallel to the side wall and into the heat dissipating element.

Implementations of this aspect of the disclosure may include one or more of the following optional features. In some examples, the layer of anisotropic material extends along an exterior surface of the side wall.

In some implementations, the layer of anisotropic material extends along an interior surface of the side wall. In some further implementations, at least one layer of electrically insulating material extends along the layer of anisotropic material.

In some configurations, another layer of anisotropic material extends along the second end of the enclosure. In some further configurations, the other layer of anisotropic material extends along an exterior surface of the second end of the enclosure. In some even further configurations, the layer of anisotropic material has a first surface roughness and the other layer of anisotropic material has a second surface roughness, the first surface roughness being greater than the second surface roughness. In some other configurations, the other layer of anisotropic material extends along an interior surface of the second end of the enclosure.

In some examples, the layer of anisotropic material includes a polyethylene terephthalate (PET) substrate.

In some implementations, the layer of anisotropic material includes graphite.

Another aspect of the disclosure provides a cell for a prismatic battery assembly. The cell includes an enclosure. The enclosure includes a first end and a second end, wherein a heat dissipating element extends along the second end. The enclosure further includes a side wall and a terminal wherein the terminal is disposed at the first end. The side wall extends between the first end and the second end, wherein a layer of anisotropic material extends in a direction parallel to the side wall. The layer of anisotropic material has a first level of thermal conductivity in the direction parallel to the side wall and a second level of thermal conductivity in a direction transverse to the side wall. The first level of thermal conductivity is greater than the second level of thermal conductivity. During operation of the prismatic battery assembly, heat generated within the enclosure of the cell is dissipated along the layer of anisotropic material in the direction parallel to the side wall and into the heat dissipating element.

Implementations of this aspect of the disclosure may include one or more of the following optional features. In some examples, the layer of anisotropic material extends along an exterior surface of the side wall.

In some implementations, the layer of anisotropic material extends along an interior surface of the side wall.

In some configurations, another layer of anisotropic material extends along the second end of the enclosure.

In some examples, the layer of anisotropic material includes at least one from the group consisting of i) graphite, and ii) a polyethylene terephthalate (PET) substrate.

Yet another aspect of the disclosure provides a vehicle. The vehicle includes a prismatic battery assembly. The prismatic battery assembly includes a cell, a heat dissipating element, and a layer of anisotropic material. The cell includes an enclosure having a first end, a second end, a side wall extending between the first end and the second end, and a terminal disposed at the first end. The heat dissipating element extends along the second end. The layer of anisotropic material extends in a direction parallel to the side wall. The anisotropic material has a first level of thermal conductivity in the direction parallel to the side wall and a second level of thermal conductivity in a direction transverse to the side wall. The first level of thermal conductivity is greater than the second level of thermal conductivity. During operation of the prismatic battery assembly, heat generated within the enclosure of the cell is dissipated along the layer of anisotropic material in the direction parallel to the side wall and into the heat dissipating element.

Implementations of this aspect of the disclosure may include one or more of the following optional features. In some examples, the layer of anisotropic material extends along an exterior surface of the side wall.

In some implementations, the layer of anisotropic material extends along an interior surface of the side wall.

In some configurations, another layer of anisotropic material extends along the second end of the enclosure.

In some examples, the layer of anisotropic material includes at least one from the group consisting of i) graphite, and ii) a polyethylene terephthalate (PET) substrate.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle including a prismatic battery assembly according to the present disclosure;

FIG. 2A is a sectional view of a prismatic battery assembly according to the present disclosure;

FIG. 2B is a sectional view of a portion of a cell of the prismatic battery assembly of FIG. 2A showing a thermal conductivity gradient of a layer of anisotropic material disposed at the cell;

FIG. 2C is a chart showing a temperature gradient of a cell of a prismatic battery assembly having an aluminum casing and with an electrolyte at a bottom portion of the cell;

FIG. 2D is a chart showing a temperature gradient of a cell of a prismatic battery assembly having a steel casing and with an electrolyte at a bottom portion of the cell;

FIG. 2E is a chart showing a temperature gradient of the cell of FIG. 2B with an electrolyte at a bottom portion of the cell and a thickness of the layer of anisotropic material of 0.1 millimeters;

FIG. 2F is a chart showing a temperature gradient of a cell of a prismatic battery assembly having an aluminum casing and with air at a bottom portion of the cell;

FIG. 2G is a chart showing a temperature gradient of a cell of a prismatic battery assembly having a steel casing and with air at a bottom portion of the cell;

FIG. 2H is a chart showing a temperature gradient of the cell of FIG. 2B with air at a bottom portion of the cell and a thickness of the layer of anisotropic material of 0.1 millimeters;

FIG. 3A is a sectional view of a portion of a cell of a prismatic battery assembly according to the present disclosure;

FIG. 3B is a sectional view of a portion of the cell of the prismatic battery assembly of FIG. 3A showing a thermal conductivity gradient of a layer of anisotropic material disposed at the cell;

FIG. 3C is a chart showing a temperature gradient of the cell of FIG. 3B with air at a bottom portion of the cell and a thickness of the layer of anisotropic material of 0.05 millimeters;

FIG. 3D is a chart showing a temperature gradient of the cell of FIG. 3B with air at a bottom portion of the cell and a thickness of the layer of anisotropic material of 0.1 millimeters;

FIG. 3E is a chart comparing a maximum operating temperature of the cell of FIG. 3B with air at a bottom portion of the cell and with an electrolyte at the bottom portion of the cell at varying thicknesses of the layer of anisotropic material;

FIG. 4A is a sectional view of a portion of a cell of a prismatic battery assembly according to the present disclosure;

FIG. 4B is a sectional view of a portion of the cell of the prismatic battery assembly of FIG. 4A showing a thermal conductivity gradient of a layer of anisotropic material disposed at the cell;

FIG. 4C is a chart showing a temperature gradient of the cell of FIG. 4B with air at a bottom portion of the cell and a thickness of the layer of anisotropic material of 0.05 millimeters;

FIG. 4D is a chart showing a temperature gradient of the cell of FIG. 4B with air at a bottom portion of the cell and a thickness of the layer of anisotropic material of 0.1 millimeters;

FIG. 4E is a chart comparing a maximum operating temperature of the cell of FIG. 4B with air at a bottom portion of the cell and with an electrolyte at the bottom portion of the cell at varying thicknesses of the layer of anisotropic material;

FIG. 4F a chart showing maximum operating temperatures of the cells of FIGS. 2B, 3B, and 4B at varying thicknesses of the layer of anisotropic material;

FIG. 5 is a sectional view of a portion of a cell of a prismatic battery assembly according to the present disclosure; and

FIG. 6 is a sectional view of a portion of a cell of a prismatic battery assembly according to the present disclosure;

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

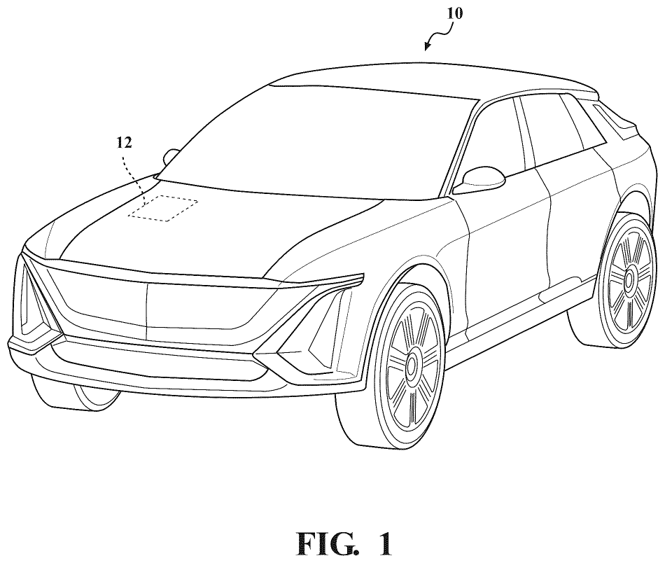

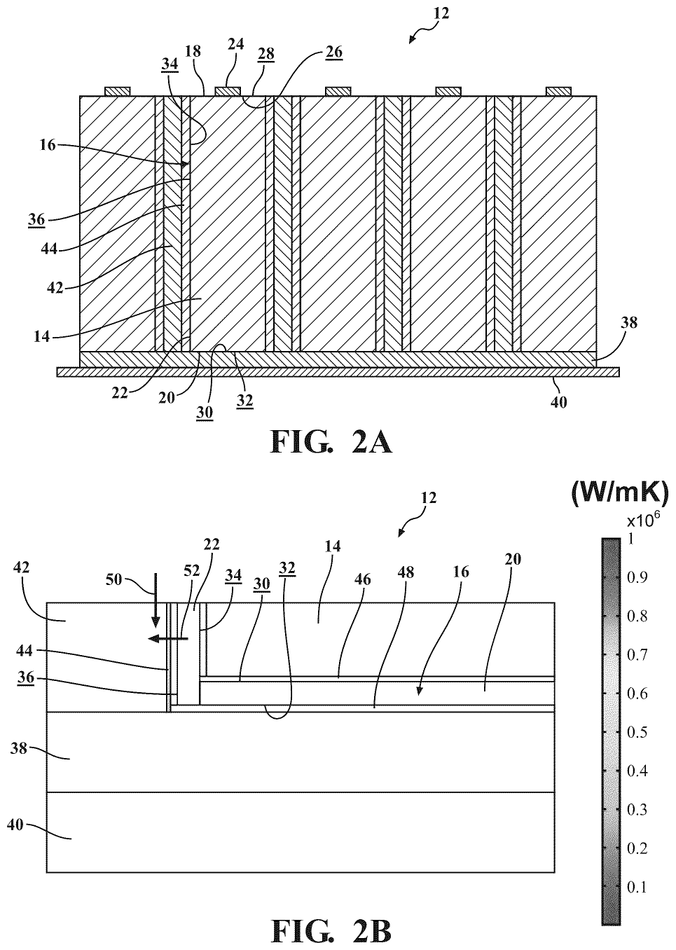

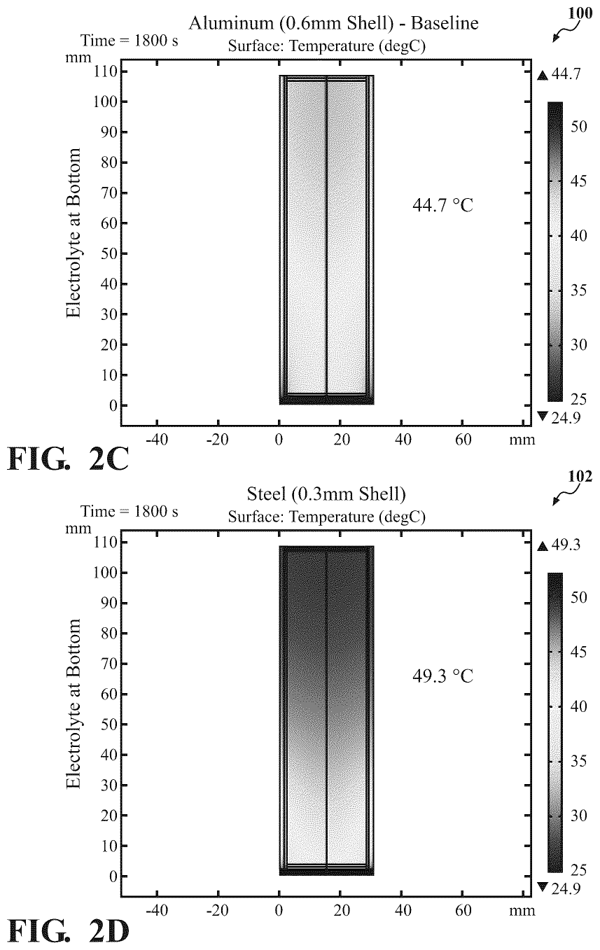

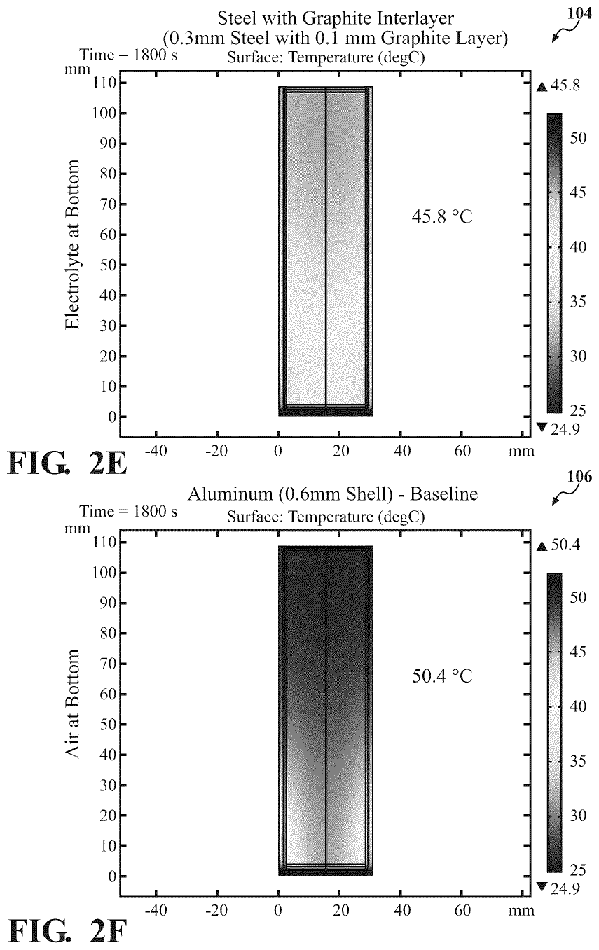

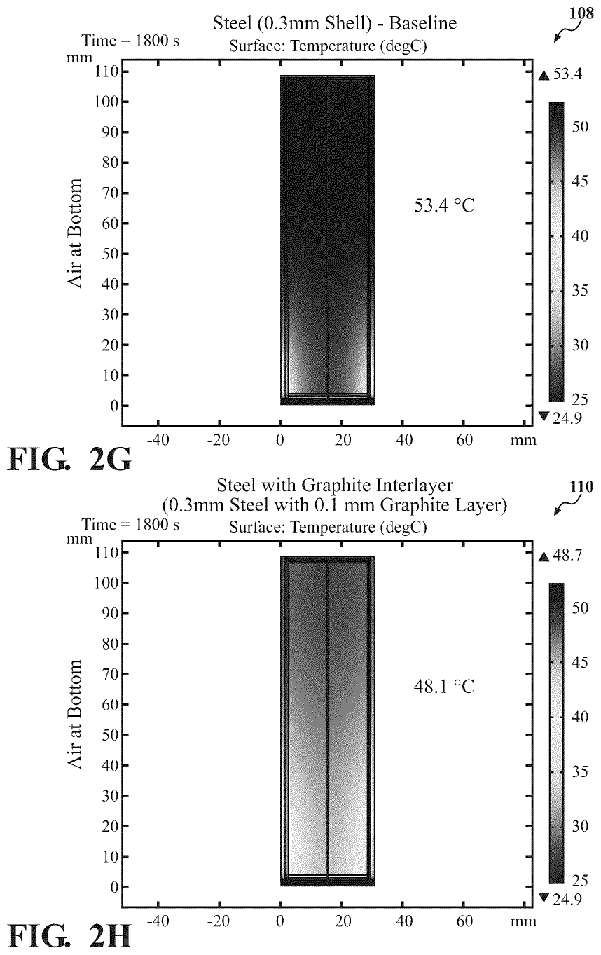

With reference to FIGS. 1-2B, a vehicle 10 includes a rechargeable battery assembly 12 that electrically powers one or more components of the vehicle 10. For example, the vehicle 10 may be an electric vehicle or a plug-in hybrid vehicle or a hybrid vehicle, and the rechargeable battery assembly 12 may be a prismatic battery, such as a lithium-ion battery or a nickel-metal hydride battery, that at least partially powers a propulsion system of the vehicle 10. Accordingly, the prismatic battery assembly 12 receives electrical current to charge the prismatic battery assembly 12, such as from an external charging device or an onboard charging system, and the prismatic battery assembly 12 discharges electrical current to power the components of the vehicle 10.

The prismatic battery assembly 12 includes a plurality of battery cells 14 that receive and discharge electrical current during operation of the prismatic battery assembly 12. Each battery cell 14 includes an enclosure 16 or a casing that houses, for example, the electrodes or electrode stack of the battery cell 14. As the prismatic battery assembly 12 is operated, heat is generated within the enclosure 16 of the battery cells 14.

The enclosure 16 is formed from a steel or a steel-alloy material and includes a first end wall 18 and a second end wall 20 opposite the first end wall 18. The enclosure 16 also includes one or more side walls 22 that extend between the first end wall 18 and the second end wall 20. For example, the enclosure 16 may have a cylindrical side wall extending between the first end wall 18 and the second end wall 20, or the enclosure 16 may include four side walls extending between the first end wall 18 and the second end wall 20 to form a cuboid shaped cell 14. In the illustrated example, the enclosure 16 includes a terminal 24 disposed at the first end wall 18. The terminal 24 provides an electrical connection between the prismatic battery assembly 12 and electrical components included in the vehicle 10.

The first end wall 18 of the enclosure 16 includes an interior surface 26 and an exterior surface 28 opposite the interior surface 26. The interior surface 26 of the first end wall 18 may interface with the electrode stack of the battery cell 14, while the exterior surface 28 of the first end wall 18 faces external of the battery cell 14. Likewise, the second end wall 20 of the enclosure 16 includes an interior surface 30 and an exterior surface 32 opposite the interior surface 30. The interior surface 30 of the second end wall 20 interfaces with the battery cell 14, while the exterior surface 32 of the second end wall 20 faces external of the battery cell 14. In a similar manner, the side wall 22 includes an interior surface 34 and an exterior surface 36 opposite the interior surface 34. The interior surface 34 of the side wall 22 interfaces with the electrode stack of the battery cell 14, while the exterior surface 36 of the side wall 22 faces external of the battery cell 14.

A thermal interface material (TIM) 38 is disposed below the cells 14 of the prismatic battery assembly 12 and thermally conductively connects the cells 14 to a heat dissipating element or cold plate 40 for regulating temperature of the prismatic battery assembly 12. For example, the TIM 38 may interface with the exterior surface 32 of the second end walls 20 of the battery cells 14 and be disposed between the cold plate 40 and the cells 14. The TIM 38 and the cold plate 40 may cooperatively act as a heat sink or a heat spreader to enable efficient thermal transfer from the battery cell 14 during its operation.

With reference to FIGS. 2A-2H, a thermal runaway barrier (TRB) 42 is disposed between the exterior surface 36 of the side wall 22 of the enclosure 16 and an adjacent battery cell 14. In other words, the TRB 42 acts as a barrier between each battery cell 14 to limit the transfer of heat between the battery cells 14. In this regard, the TRB 42 helps to reduce the potential of a thermal runaway event from spreading between cells 14 of the prismatic battery assembly 12.

To further resist damage to the cells 14 of the prismatic battery assembly 12 during a thermal runaway event, the enclosure 16 is formed from a steel or steel alloy material. Steel and steel alloys have melting temperatures generally higher than temperatures experienced during thermal runaway events for lithium-based batteries and nickel-based batteries or other battery types with higher energy densities. Thus, the prismatic battery assembly 12 accommodates cells 14 having high energy densities like nickel-based electrode stacks. Further, use of steel or steel alloys allows the thickness of the end walls 18, 20 and the side wall 22 to be decreased, such that the walls of the enclosure 16 may have respective thicknesses between about 0.2 millimeters and 0.4 millimeters.

At the beginning of the lifecycle of the prismatic battery assembly 12, an electrolyte material may be disposed between a lower end of the electrode stack of the battery cell 14 and the interior surface 30 of the second end wall 20. The electrolyte material assists in transferring heat from the electrode stack to the second end wall 20 and toward the TIM 38 and cold plate 40. As the prismatic battery assembly 12 is operated, the electrolyte material may be consumed and an air gap may form between the electrode stack and the interior surface 30 of the second end wall 20. The air gap may not transfer heat between the electrode stack and the second end wall 20 as efficiently as the electrolyte material, leading to higher operating temperatures for the prismatic battery assembly 12.

Because steel and steel alloys have a lower thermal conductivity than, for example, aluminum, a layer of anisotropic material 44 is disposed at the exterior surface 36 of the side wall 22 and extends in a direction parallel to the side wall 22. In other words, the layer of anisotropic material 44 is positioned between the exterior surface 36 of the side wall 22 and the TRB 42. The layer of anisotropic material 44 includes graphite and is configured to dissipate heat that is generated within the battery cell 14. For example, heat generated within the enclosure 16 is dissipated at least partially through the side wall 22 and into the layer of anisotropic material 44. The layer of anisotropic material 44 is configured to allow a first degree of heat transfer in a direction parallel to the layer of anisotropic material 44 extending along the side wall 22 and to allow a second degree of heat transfer in at least one direction transverse to the layer of anisotropic material 44 along the side wall 22. In other words, the layer of anisotropic material 44 directs heat along the side wall 22 toward the TIM 38 and the cold plate 40 for further dissipation away from the cells 14, and the layer of anisotropic material 44 resists heat transfer from the side wall 22 of the enclosure 16 in directions toward adjacent cells 14.

Put another way, the layer of anisotropic material 44 has a first level of thermal conductivity 50 extending in the direction parallel to the side wall 22. Additionally, the layer of anisotropic material 44 has a second level of thermal conductivity 52 extending in a direction transverse to the side wall 22. In reference to FIG. 2B, the first level of thermal conductivity 50 is represented by the arrow pointing in the direction parallel to the side wall 22 and the second level of thermal conductivity 52 is represented by the arrow pointing perpendicular to the side wall 22. In other examples, the layer of anisotropic material 44 may resist and direct the transfer of heat to varying degrees in any suitable direction relative to the walls of the enclosure 16. In the illustrated example, the first level of thermal conductivity 50 is greater than the second level of thermal conductivity 52. In other words, heat transfer occurs more efficiently and quicker in the direction parallel to the side wall 22 compared to the direction transverse to the side wall 22. For example, the first level of thermal conductivity 50 may be at or near 1800 Watts per meter-Kelvin (W/mK), while the second level of thermal conductivity 52 may be at or near 15 W/mK.

During operation of the prismatic battery assembly 12, heat generated within the battery cell 14 transfers through the side wall 22 and eventually reaches the layer of anisotropic material 44. The first level of thermal conductivity 50 enables quick and efficient transfer of heat through the layer of anisotropic material 44 in the direction parallel to the side wall 22 from the first end wall 18 of the enclosure 16 toward the second end wall 20 of the enclosure 16. The second level of thermal conductivity 52 resists transfer of heat through the layer of anisotropic material 44 in the direction transverse to the side wall 22. In this regard, heat is enabled to travel out of the battery cell 14, into the layer of anisotropic material 44, and toward the TIM 38 and the cold plate 40. Due to the second level of thermal conductivity 52 being lower than the first level of thermal conductivity 50, heat transfer is resisted through the layer of anisotropic material 44 in the direction transverse to the side wall 22. In this regard, heat is generally prevented from traveling into the TRB 42, as the vast majority of generated heat travels into the TIM 38 and the cold plate 40.

The layer of anisotropic material 44 allows the prismatic battery assembly 12 having the thin steel enclosure 16 to operate at temperatures similar to those experienced by batteries having typical, thicker aluminum enclosures. For example, and as shown in FIG. 2C-2H, at 100, a rechargeable battery having cells with aluminum enclosures that are about 0.6 millimeters thick may operate at a temperature of about 44.7 degrees Celsius at the beginning of the battery life cycle (i.e., with an electrolyte present) and, at 106, at about 50.4 degrees Celsius toward the end of the battery life cycle (i.e., with the electrolyte consumed and an air gap present). At 102, a rechargeable battery having cells with steel enclosures that are about 0.3 millimeters thick and with no layer of anisotropic material may operate at about 49.3 degrees Celsius at the beginning of the battery life cycle and, 108, at about 53.4 degrees Celsius toward the end of the battery life cycle. At 104, the prismatic battery assembly 12 having the cells 14 with the steel enclosure 16 that are about 0.3 millimeters thick may operate at about 45.8 degrees Celsius at the beginning of the battery life cycle and, at 110, at about 48.1 degrees Celsius toward the end of the battery life cycle.

Furthermore, the prismatic battery assembly 12 includes a layer of polypropylene (PP) 46 and a layer of polyethylene terephthalate (PET) 48. The layer of PP 46 is disposed at the interior surface 34 of the side wall 22 and the interior surface 30 of the second end wall 20 of the enclosure 16. The layer of PET 48 is disposed at the exterior surface 36 of the side wall 22 and the exterior surface 32 of the second end wall 20 of the enclosure 16. The layer of PP 46 behaves as an electrically insulating material and is configured to isolate the components contained within the battery cell 14, such as the electrode stack, from the enclosure 16. In a similar manner, the layer of PET 48 is configured to electrically insulate the battery cell 14 and provides mechanical structure and chemical stability to the battery cell 14. In this configuration, the layer of PET 48 is disposed between the enclosure 16 and the layer of anisotropic material 44.

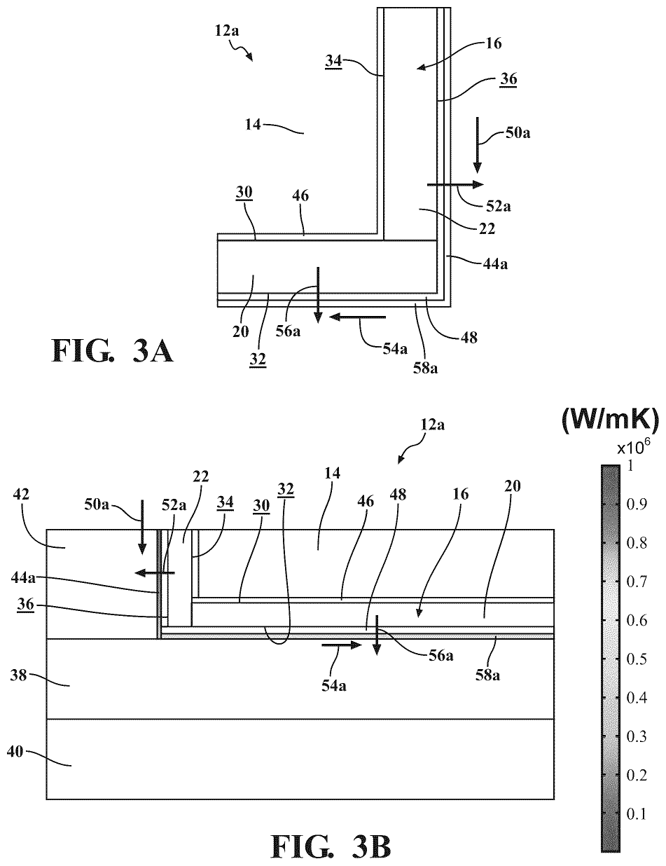

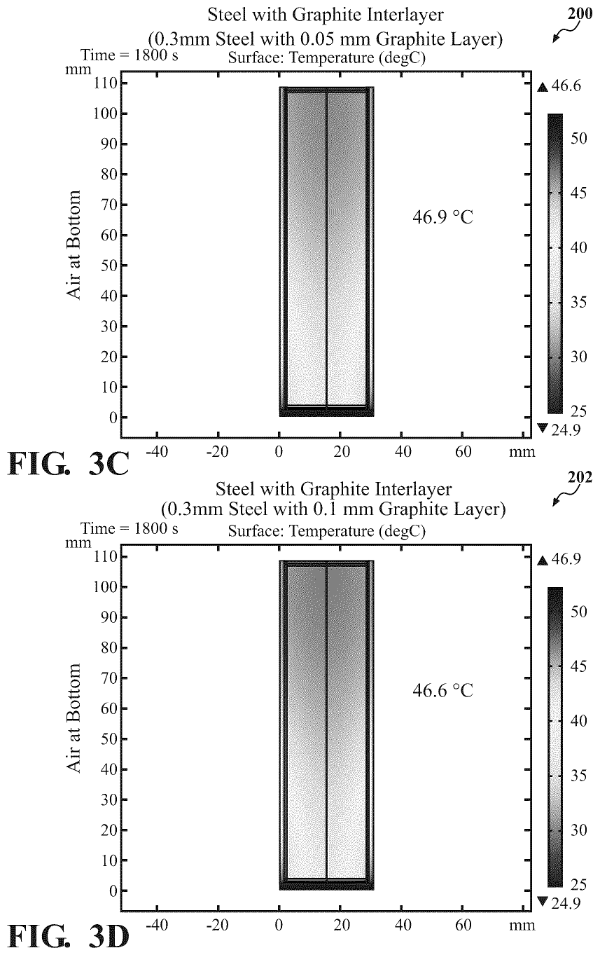

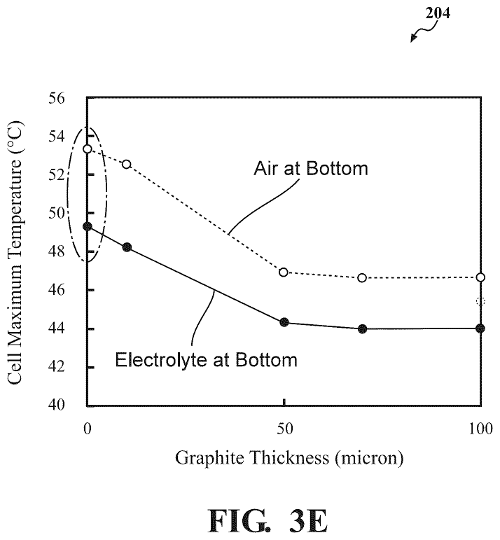

In some examples, the prismatic battery assembly includes a second layer of anisotropic material between the lower end wall and the TIM. The second layer of anisotropic material may extend beneath a plurality of the cells of the battery to spread heat generated by the cells more evenly along the TIM, leading to more efficient heat transfer to the TIM and away from the cells of the battery. For example, and with particular reference to FIGS. 3A-3E, a prismatic battery assembly 12a includes a horizontal layer or lower layer of anisotropic material between the second end wall 20 and the TIM 38. In view of the substantial similarity in structure and function of the components associated with the prismatic battery assembly 12, like reference numerals are used hereinafter and in the drawings to identify like components while like reference numerals containing letter and number extensions are used to identify those components that have been modified.

The prismatic battery assembly 12a includes an enclosure 16 formed from a steel or a steel-alloy material and that includes a first end wall and a second end wall 20 opposite the first end wall. The enclosure 16 also includes one or more side walls 22 that extends between the first end wall and the second end wall 20. The first end wall of the enclosure 16 includes an interior surface and an exterior surface opposite the interior surface. The interior surface of the first end wall may interface with the electrode stack of the battery cell 14, while the exterior surface of the first end wall faces external of the battery cell 14. Likewise, the second end wall 20 of the enclosure 16 includes an interior surface 30 and an exterior surface 32 opposite the interior surface 30. The interior surface 30 of the second end wall 20 interfaces with the battery cell 14, while the exterior surface 32 of the second end wall 20 faces external of the battery cell 14. In a similar manner, the side wall 22 includes an interior surface 34 and an exterior surface 36 opposite the interior surface 34. The interior surface 34 of the side wall 22 interfaces with the electrode stack of the battery cell 14, while the exterior surface 36 of the side wall 22 faces external of the battery cell 14.

A thermal interface material (TIM) 38 is disposed below the cells 14 of the prismatic battery assembly 12a and thermally conductively connects the cells 14 to a heat dissipating element or cold plate 40 for regulating temperature of the prismatic battery assembly 12. For example, the TIM 38 may interface with the exterior surface 32 of the second end walls 20 of the battery cells 14 and be disposed between the cold plate 40 and the cells 14. The TIM 38 and the cold plate 40 may cooperatively act as a heat sink or a heat spreader to enable efficient thermal transfer from the battery cell 14 during its operation.

A thermal runaway barrier (TRB) 42 is disposed between the exterior surface 36 of the side wall 22 of the enclosure 16 and an adjacent battery cell 14. In other words, the TRB 42 acts as a barrier between each battery cell 14 to limit the transfer of heat between the battery cells 14. In this regard, the TRB 42 helps to reduce the potential of a thermal runaway event from spreading between cells 14 of the prismatic battery assembly 12a.

The prismatic battery assembly 12a includes a first layer of anisotropic material 44a disposed at the exterior surface 36 of the side wall 22 and extending in a direction parallel to the side wall 22. Furthermore, a second layer of anisotropic material 58a is disposed at the exterior surface 32 of the second end wall 20 and extends in a direction parallel to the second end wall 20. In other words, the first layer of anisotropic material 44a is positioned between the exterior surface 36 of the side wall 22 and the TRB 42, and the second layer of anisotropic material 58a is positioned between the exterior surface 32 of the second end wall 20 and the TIM 38. The layers of anisotropic material 44a, 58a include graphite and are configured to dissipate heat that is generated within the battery cell 14. For example, heat generated within the enclosure 16 is dissipated at least partially through the side wall 22 and into the first layer of anisotropic material 44a. Additionally, heat generated within the enclosure 16 is dissipated at least partially through the second end wall 20 and into the second layer of anisotropic material 58a. The second layer of anisotropic material 58a may extend beneath one or more of the cells 14 of the prismatic battery assembly 12a to evenly distribute heat generated by the cells 14 across the TIM 38.

The first layer of anisotropic material 44a is configured to allow a first degree of heat transfer in a direction parallel to the first layer of anisotropic material 44a along the side wall 22 and to allow a second degree of heat transfer in directions transverse to the first layer of anisotropic material 44a along the side wall 22. In other words, the first layer of anisotropic material 44a directs heat along the side wall 22 toward the TIM 38 and the cold plate 40 for further dissipation away from the cells 14, and the first layer of anisotropic material 44a resists heat transfer from the side wall 22 of the enclosure 16 in directions toward adjacent cells 14.

Additionally, the second layer of anisotropic material 58a is configured to allow a third degree of heat transfer in a direction parallel to the second layer of anisotropic material 58a along the second end wall 20 and to allow a fourth degree of heat transfer in directions transverse to the second layer of anisotropic material 58a along the second end wall 20. In other words, the second layer of anisotropic material 58a directs heat along the second end wall 20 and along the TIM 38 and the cold plate 40 for further dissipation away from the cells 14. While the third degree of heat transfer is greater than the fourth degree of heat transfer, the positioning of the second layer of anisotropic material 58a against a large surface area of the TIM 38 accommodates sufficient transfer of heat through the second layer of anisotropic material 58a into the TIM 38. In other words, heat spreads quickly at the third degree of heat transfer to spread heat across a large surface area of the TIM 38 and enabling sufficient heat transfer into the TIM 38.

Put another way, the first layer of anisotropic material 44a has a first level of thermal conductivity 50a extending in the direction parallel to the side wall 22. Additionally, the first layer of anisotropic material 44a has a second level of thermal conductivity 52a extending in a direction transverse to the side wall 22. In reference to FIGS. 3A and 3B, the first level of thermal conductivity 50a is represented by the arrow pointing in the direction parallel to the side wall 22 and the second level of thermal conductivity 52a is represented by the arrow pointing perpendicular to the side wall 22. In other examples, the first layer of anisotropic material 44a may resist and direct the transfer of heat to varying degrees in any suitable direction relative to the walls of the enclosure 16. In the illustrated example, the first level of thermal conductivity 50a is greater than the second level of thermal conductivity 52a. In other words, heat transfer occurs more efficiently and quicker in the direction parallel to the side wall 22 compared to the direction transverse to the side wall 22. For example, first level of thermal conductivity 50a may be at or near 1800 Watts per meter-Kelvin (W/mK), while the second level of thermal conductivity 52a may be at or near 15 W/mK.

The second layer of anisotropic material 58a has a third level of thermal conductivity 54a extending in the direction parallel to the second end wall 20. Additionally, the second layer of anisotropic material 58a has a fourth level of thermal conductivity 56a extending in a direction transverse to the second end wall 20. The third level of thermal conductivity 54a is represented by the arrow pointing in the direction parallel to the second end wall 20 and the fourth level of thermal conductivity 56a is represented by the arrow pointing perpendicular to the second end wall 20. In other examples, the second layer of anisotropic material 58a may resist and direct the transfer of heat to varying degrees in any suitable direction relative to the walls of the enclosure 16. In the illustrated example, the third level of thermal conductivity 54a is greater than the fourth level of thermal conductivity 56a. In other words, heat transfer occurs more efficiently and quicker in the direction parallel to the second end wall 20 compared to the direction transverse to the second end wall 20. However, heat spreads quickly across a large surface area of the TIM 38, enabling sufficient heat transfer along the second layer of anisotropic material 58a and into the TIM 38. The third level of thermal conductivity 54a may be at or near 1800 W/mK, while the fourth level of thermal conductivity 56a may be at or near 15 W/mK.

During operation of the prismatic battery assembly 12a, heat generated within the battery cell 14 transfers through the side wall 22 and the second end wall 20 and eventually reaches the first layer of anisotropic material 44a and the second layer of anisotropic material 58a. The first level of thermal conductivity 50a enables quick and efficient transfer of heat through the first layer of anisotropic material 44a in the direction parallel to the side wall 22 from the first end wall of the enclosure 16 toward the second end wall 20 of the enclosure 16. The second level of thermal conductivity 52a resists transfer of heat through the first layer of anisotropic material 44a in the direction transverse to the side wall 22. Furthermore, the third level of thermal conductivity 54a enables quick and efficient transfer of heat through the second layer of anisotropic material 58a in the direction parallel to the second end wall 20. The fourth level of thermal conductivity 56a resists transfer of heat through the second layer of anisotropic material 58a in the direction transverse to the second end wall 20. However, heat may spread across a large surface area of the TIM 38 to transfer into the TIM 38. In this regard, heat may travel out of the battery cell 14, into the layers of anisotropic material 44a, 58a and toward the TIM 38 and the cold plate 40. Due to the second level of thermal conductivity 52a being much lower than the first level of thermal conductivity 50a, heat transfer is resisted through the first layer of anisotropic material 44a in directions transverse to the side wall 22. In this regard, heat is generally prevented from traveling into the TRB 42, as the vast majority of generated heat travels into the TIM 38 and the cold plate 40.

The layers of anisotropic material 44a, 58a allows the prismatic battery assembly 12a having the thin steel enclosure 16 to operate at temperatures similar to those experienced by batteries having typical, thicker aluminum enclosures. For example, and as shown in FIG. 3C-3E, at 200, the prismatic battery assembly 12a having the cells 14 with the steel enclosure 16 that is about 0.3 millimeters thick, as well as the layers of anisotropic material 44a, 58a having a thickness of 0.05 millimeters, may operate at about 46.9 degrees Celsius at the end of the battery life cycle. At 202, the prismatic battery assembly 12a having the cells 14 with the steel enclosure 16 that is about 0.3 millimeters thick, as well as the layers of anisotropic material 44a, 58a having a thickness of about 0.1 millimeters, may operate at about 46.6 degrees Celsius at the end of the battery life cycle. In general, at 204, the maximum operating temperature of the cell 14 reduces as the layers of anisotropic material 44a, 58a increases in thickness, eventually plateauing in temperature when thickness of the layers of anisotropic material 44a, 58a is greater than about 0.075 millimeters. Furthermore, the maximum operating temperature of the cell 14 is greater at the end of the battery life cycle compared to the beginning of the battery life cycle.

Furthermore, the prismatic battery assembly 12a includes a layer of polypropylene (PP) 46 and a layer of polyethylene terephthalate (PET) 48. The layer of PP 46 is disposed at the interior surface 34 of the side wall 22 and the interior surface 30 of the second end wall 20 of the enclosure 16. The layer of PET 48 is disposed at the exterior surface 36 of the side wall 22 and the exterior surface 32 of the second end wall 20 of the enclosure 16. The layer of PP 46 behaves as an electrically insulating material and is configured to isolate the components contained within the battery cell 14, such as the electrode stack, from the enclosure 16. In a similar manner, the layer of PET 48 is configured to electrically insulate the battery cell 14, but also provides mechanical structure and chemical stability to the battery cell 14. In this configuration, the layer of PET 48 is disposed between the enclosure 16 and the layer of anisotropic material 44a.

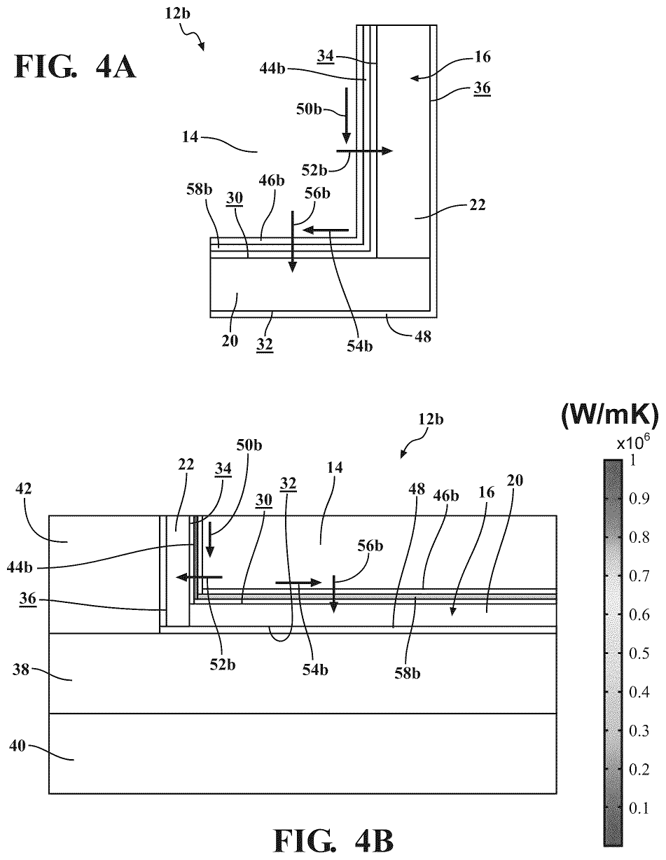

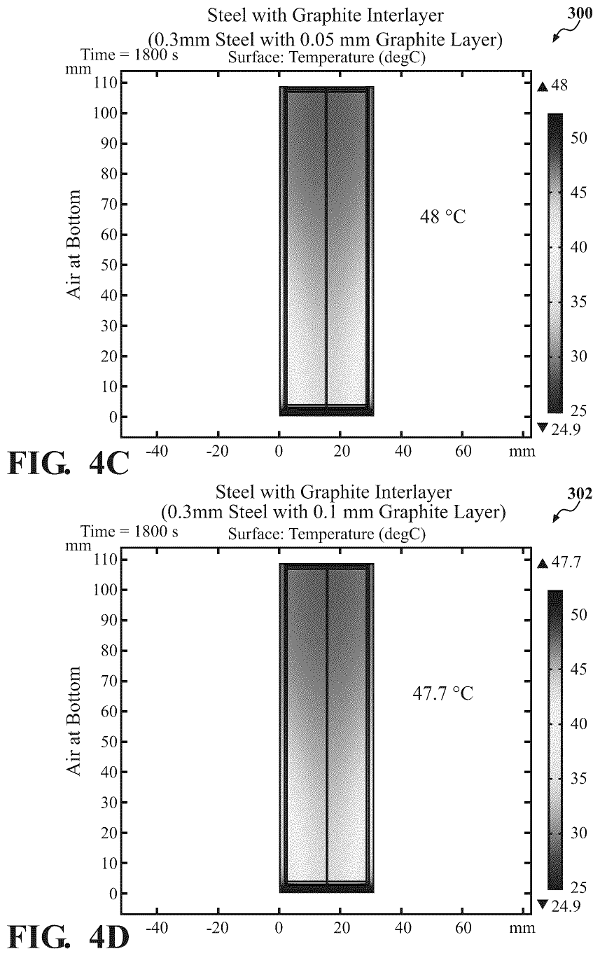

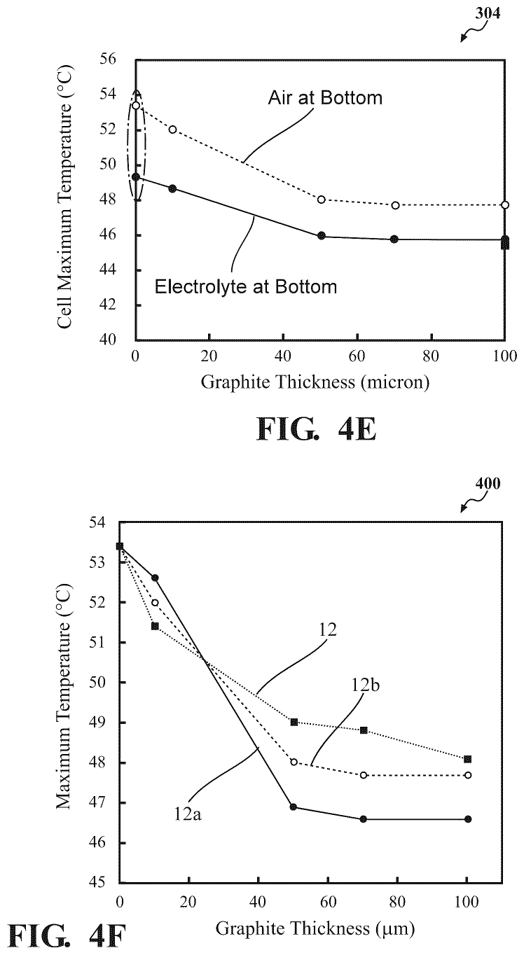

In some examples, the prismatic battery assembly includes a first layer of anisotropic material disposed at the interior surface of the side wall and a second layer of anisotropic material disposed at the interior surface of the second end wall. The positioning of the anisotropic material at interior surfaces of the enclosure isolates the electrode stack, and other components contained within the cell, from the enclosure. As a result, a PP-graphite-PP double sided tape may be used to encapsulate the layers of anisotropic material within the PP. For example, and with particular reference to FIGS. 4A-4E, a prismatic battery assembly 12b includes a first layer of anisotropic material and a second layer of anisotropic material contained internal to the cell and within the bounds of the enclosure. In view of the substantial similarity in structure and function of the components associated with the prismatic battery assembly 12, like reference numerals are used hereinafter and in the drawings to identify like components while like reference numerals containing letter and number extensions are used to identify those components that have been modified.

The prismatic battery assembly 12b includes an enclosure 16 formed from a steel or a steel-alloy material and that includes a first end wall and a second end wall 20 opposite the first end wall. The enclosure 16 also includes one or more side walls 22 that extends between the first end wall and the second end wall 20. The first end wall of the enclosure 16 includes an interior surface and an exterior surface opposite the interior surface. The interior surface of the first end wall may interface with the electrode stack of the battery cell 14, while the exterior surface of the first end wall faces external of the battery cell 14. Likewise, the second end wall 20 of the enclosure 16 includes an interior surface 30 and an exterior surface 32 opposite the interior surface 30. The interior surface 30 of the second end wall 20 interfaces with the battery cell 14, while the exterior surface 32 of the second end wall 20 faces external of the battery cell 14. In a similar manner, the side wall 22 includes an interior surface 34 and an exterior surface 36 opposite the interior surface 34. The interior surface 34 of the side wall 22 interfaces with the electrode stack of the battery cell 14, while the exterior surface 36 of the side wall 22 faces external of the battery cell 14.

A thermal interface material (TIM) 38 is disposed below the cells 14 of the prismatic battery assembly 12b and thermally conductively connects the cells 14 to a heat dissipating element or cold plate 40 for regulating temperature of the prismatic battery assembly 12. For example, the TIM 38 may interface with the exterior surface 32 of the second end walls 20 of the battery cells 14 and be disposed between the cold plate 40 and the cells 14. The TIM 38 and the cold plate 40 may cooperatively act as a heat sink or a heat spreader to enable efficient thermal transfer from the battery cell 14 during its operation.

A thermal runaway barrier (TRB) 42 is disposed between the exterior surface 36 of the side wall 22 of the enclosure 16 and an adjacent battery cell 14. In other words, the TRB 42 acts as a barrier between each battery cell 14 to limit the transfer of heat between the battery cells 14. In this regard, the TRB 42 helps to reduce the potential of a thermal runaway event from spreading between cells 14 of the prismatic battery assembly 12b.

The prismatic battery assembly 12b includes a first layer of anisotropic material 44b disposed at the interior surface 34 of the side wall 22 and extending in a direction parallel to the side wall 22. Furthermore, a second layer of anisotropic material 58b is disposed at the interior surface 30 of the second end wall 20 and extends in a direction parallel to the second end wall 20. The layers of anisotropic material 44b, 58b include graphite and are configured to dissipate heat that is generated within the battery cell 14. For example, heat generated within the enclosure 16 is dissipated at least partially into the first layer of anisotropic material 44b and through the side wall 22. Additionally, heat generated within the enclosure 16 is dissipated at least partially into the second layer of anisotropic material 58b and through the second end wall 20. The second layer of anisotropic material 58b may extend beneath one or more of the cells 14 of the prismatic battery assembly 12b to evenly distribute heat generated by the cells 14 across the TIM 38.

The first layer of anisotropic material 44b is configured to allow a first degree of heat transfer in a direction parallel to the first layer of anisotropic material 44b along the side wall 22 and to allow a second degree of heat transfer in directions transverse to the first layer of anisotropic material 44b along the side wall 22. In other words, the first layer of anisotropic material 44b directs heat along the side wall 22 toward the TIM 38 and the cold plate 40 for further dissipation away from the cells 14, and the first layer of anisotropic material 44b resists heat transfer from the side wall 22 of the enclosure 16 in directions toward adjacent cells 14.

Additionally, the second layer of anisotropic material 58b is configured to allow a third degree of heat transfer in a direction parallel to the second layer of anisotropic material 58b along the second end wall 20 and to allow a fourth degree of heat transfer in directions transverse to the second layer of anisotropic material 58b along the second end wall 20. In other words, the second layer of anisotropic material 58b directs heat along the second end wall 20 and along the TIM 38 and the cold plate 40 for further dissipation away from the cells 14. While the third degree of heat transfer is greater than the fourth degree of heat transfer, the positioning of the second layer of anisotropic material 58b adjacent to a large surface area of the TIM 38 accommodates sufficient transfer of heat through the second layer of anisotropic material 58b into the TIM 38. In other words, heat spreads quickly at the third degree of heat transfer to spread heat across a large surface area of the TIM 38 and enabling sufficient heat transfer through the second end wall 20 and into the TIM 38.

Put another way, the first layer of anisotropic material 44b has a first level of thermal conductivity 50b extending in the direction parallel to the side wall 22. Additionally, the first layer of anisotropic material 44b has a second level of thermal conductivity 52b extending in a direction transverse to the side wall 22. In reference to FIGS. 3A and 3B, the first level of thermal conductivity 50b is represented by the arrow pointing in the direction parallel to the side wall 22 and the second level of thermal conductivity 52b is represented by the arrow pointing perpendicular to the side wall 22. In other examples, the first layer of anisotropic material 44b may resist and direct the transfer of heat to varying degrees in any suitable direction relative to the walls of the enclosure 16. In the illustrated example, the first level of thermal conductivity 50b is greater than the second level of thermal conductivity 52b. In other words, heat transfer occurs more efficiently and quicker in the direction parallel to the side wall 22 compared to the direction transverse to the side wall 22. For example, first level of thermal conductivity 50b may be at or near 1800 Watts per meter-Kelvin (W/mK), while the second level of thermal conductivity 52b may be at or near 15 W/mK.

The second layer of anisotropic material 58b has a third level of thermal conductivity 54b extending in the direction parallel to the second end wall 20. Additionally, the second layer of anisotropic material 58b has a fourth level of thermal conductivity 56b extending in a direction transverse to the second end wall 20. The third level of thermal conductivity 54b is represented by the arrow pointing in the direction parallel to the second end wall 20 and the fourth level of thermal conductivity 56b is represented by the arrow pointing perpendicular to the second end wall 20. In other examples, the second layer of anisotropic material 58b may resist and direct the transfer of heat to varying degrees in any suitable direction relative to the walls of the enclosure 16. In the illustrated example, the third level of thermal conductivity 54b is greater than the fourth level of thermal conductivity 56b. In other words, heat transfer occurs more efficiently and quicker in the direction parallel to the second end wall 20 compared to the direction transverse to the second end wall 20. However, heat spreads quickly across a large surface area of the TIM 38, enabling sufficient heat transfer along the second layer of anisotropic material 58b and into the TIM 38. The third level of thermal conductivity 54b may be at or near 1800 W/mK, while the fourth level of thermal conductivity 56b may be at or near 15 W/mK.

During operation of the prismatic battery assembly 12b, heat generated within the battery cell 14 transfers through the first layer of anisotropic material 44b and the second layer of anisotropic material 58b and eventually reaches the side wall 22 and the second end wall. The first level of thermal conductivity 50b enables quick and efficient transfer of heat through the first layer of anisotropic material 44b in the direction parallel to the side wall 22 from the first end wall of the enclosure 16 toward the second end wall 20 of the enclosure 16. The second level of thermal conductivity 52b resists transfer of heat through the first layer of anisotropic material 44b in the direction transverse to the side wall 22. Furthermore, the third level of thermal conductivity 54b enables quick and efficient transfer of heat through the second layer of anisotropic material 58b in the direction parallel to the second end wall 20. The fourth level of thermal conductivity 56b resists transfer of heat through the second layer of anisotropic material 58b in the direction transverse to the second end wall 20. However, heat may spread across a large surface area of the TIM 38 to transfer into the TIM 38. In this regard, heat may travel through the first level of anisotropic material 44b and the second layer of anisotropic material 58b, out of the enclosure 16 of the battery cell 14, and toward the TIM 38 and the cold plate 40. Due to the second level of thermal conductivity 52b being much lower than the first level of thermal conductivity 50b, heat transfer is resisted through the first layer of anisotropic material 44b in directions transverse to the side wall 22. In this regard, heat is generally prevented from traveling into the TRB 42, as the vast majority of generated heat travels into the TIM 38 and the cold plate 40.

The first layer of anisotropic material 44b allows the prismatic battery assembly 12b having the thin steel enclosure 16 to operate at temperatures similar to those experienced by batteries having typical, thicker aluminum enclosures. For example, and as shown in FIG. 4C-4E, at 300, the prismatic battery assembly 12b having the cells 14 with the steel enclosure 16 that is about 0.3 millimeters thick, as well as the layers of anisotropic material 44b, 58b having a thickness of 0.05 millimeters, may operate at about 48 degrees Celsius at the end of the battery life cycle. At 302, the prismatic battery assembly 12b having the cells 14 with the steel enclosure 16 that is about 0.3 millimeters thick, as well as the layers of anisotropic material 44b, 58b having a thickness of about 0.1 millimeters, may operate at about 47.7 degrees Celsius at the end of the battery life cycle. In general, at 304, the maximum operating temperature of the cell 14 reduces as the layers of anisotropic material 44b, 58b increases in thickness, eventually plateauing in temperature when thickness of the layers of anisotropic material 44b, 58b is greater than about 0.075 millimeters. Furthermore, the maximum operating temperature of the cell 14 is greater at the end of the battery life cycle compared to the beginning of the battery life cycle.

Furthermore, the prismatic battery assembly 12b includes a layer of polypropylene (PP) 46 and a layer of polyethylene terephthalate (PET) 48. The layer of PP 46 is disposed at the interior surface 34 of the side wall 22 and the interior surface 30 of the second end wall 20 of the enclosure 16. The layer of PET 48 is disposed at the exterior surface 36 of the side wall 22 and the exterior surface 32 of the second end wall 20 of the enclosure 16. The layer of PP 46 behaves as an electrically insulating material and is configured to isolate the components contained within the battery cell 14, such as the electrode stack, from the enclosure 16. In a similar manner, the layer of PET 48 is configured to electrically insulate the battery cell 14, but also provides mechanical structure and chemical stability to the battery cell 14. In this configuration, the layer of PP 46 encapsulates the layers of anisotropic materials 44b, 58b.

With reference to FIG. 4F, at 400, the maximum operating temperature of the cell 14 varies based on the configuration of the prismatic battery assembly 12, 12a, 12b, and specifically, the configuration of the layers of anisotropic material 44, 44a, 58a, 44b, 58b. As the thickness of the layer of anisotropic material 44, 44b, 58b increases, the prismatic battery assembly 12 generally has a greater maximum operating temperature of the cell 14 compared to the prismatic battery assembly 12b. Additionally, as the thickness of the layer of anisotropic material 44a, 58a, 44b, 58b increases, the prismatic battery assembly 12b generally has a greater maximum operating temperature of the cell 14 compared to the prismatic battery assembly 12a.

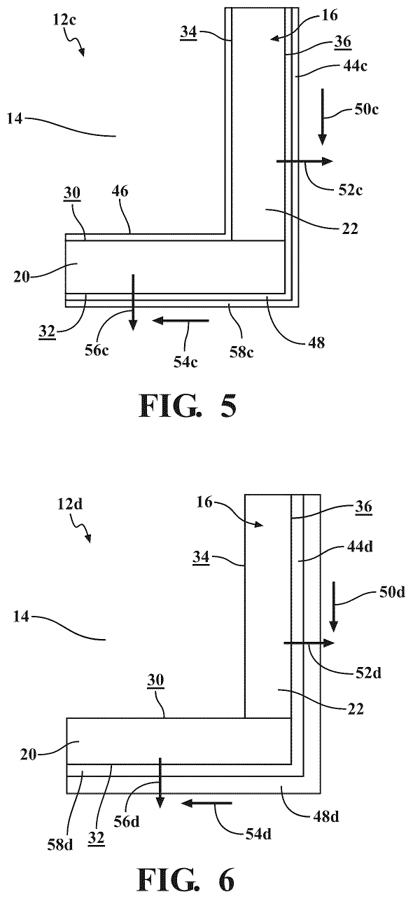

In some examples, the prismatic battery assembly includes a first layer of anisotropic material with a first level of roughness and a second layer of anisotropic material with a second level of roughness. The first level of roughness is greater than the second level of roughness, and in this regard, heat transfer can occur more effectively and efficiently through the second layer of anisotropic material than through the first layer of anisotropic material. For example, and with particular reference to FIG. 5, a prismatic battery assembly 12c includes a first layer of anisotropic material with a first level of roughness and a second layer of anisotropic material with a second level of roughness. In view of the substantial similarity in structure and function of the components associated with the prismatic battery assembly 12, like reference numerals are used hereinafter and in the drawings to identify like components while like reference numerals containing letter and number extensions are used to identify those components that have been modified.

The prismatic battery assembly 12c includes an enclosure 16 formed from a steel or a steel-alloy material and that includes a first end wall and a second end wall 20 opposite the first end wall. The enclosure 16 also includes one or more side walls 22 that extends between the first end wall and the second end wall 20. The first end wall of the enclosure 16 includes an interior surface and an exterior surface opposite the interior surface. The interior surface of the first end wall may interface with the electrode stack of the battery cell 14, while the exterior surface of the first end wall faces external of the battery cell 14. Likewise, the second end wall 20 of the enclosure 16 includes an interior surface 30 and an exterior surface 32 opposite the interior surface 30. The interior surface 30 of the second end wall 20 interfaces with the battery cell 14, while the exterior surface 32 of the second end wall 20 faces external of the battery cell 14. In a similar manner, the side wall 22 includes an interior surface 34 and an exterior surface 36 opposite the interior surface 34. The interior surface 34 of the side wall 22 interfaces with the electrode stack of the battery cell 14, while the exterior surface 36 of the side wall 22 faces external of the battery cell 14.

A thermal interface material (TIM) is disposed below the cells 14 of the prismatic battery assembly 12c and thermally conductively connects the cells 14 to a heat dissipating element or cold plate for regulating temperature of the prismatic battery assembly 12c. For example, the TIM may interface with the exterior surface 32 of the second end walls 20 of the battery cells 14 and be disposed between the cold plate and the cells 14. The TIM and the cold plate may cooperatively act as a heat sink or a heat spreader to enable efficient thermal transfer from the battery cell 14 during its operation.

A thermal runaway barrier (TRB) is disposed between the exterior surface 36 of the side wall 22 of the enclosure 16 and an adjacent battery cell 14. In other words, the TRB acts as a barrier between each battery cell 14 to limit the transfer of heat between the battery cells 14. In this regard, the TRB helps to reduce the potential of a thermal runaway event from spreading between cells 14 of the prismatic battery assembly 12c.

The prismatic battery assembly 12c includes a first layer of anisotropic material 44c disposed at the exterior surface 36 of the side wall 22 and extending in a direction parallel to the side wall 22. Furthermore, a second layer of anisotropic material 58c is disposed at the exterior surface 32 of the second end wall 20 and extends in a direction parallel to the second end wall 20. In other words, the first layer of anisotropic material 44c is positioned between the exterior surface 36 of the side wall 22 and the TRB, and the second layer of anisotropic material 58c is positioned between the exterior surface 32 of the second end wall 20 and the TIM. The layers of anisotropic material 44c, 58c include graphite and are configured to dissipate heat that is generated within the battery cell 14. For example, heat generated within the enclosure 16 is dissipated at least partially through the side wall 22 and into the first layer of anisotropic material 44c. Additionally, heat generated within the enclosure 16 is dissipated at least partially through the second end wall 20 and into the second layer of anisotropic material 58c. The second layer of anisotropic material 58c may extend beneath one or more of the cells 14 of the prismatic battery assembly 12c to evenly distribute heat generated by the cells 14 across the TIM.

The first layer of anisotropic material 44c has a first surface roughness, while the second layer of anisotropic material 58c has a second surface roughness. The first surface roughness is greater than the second surface roughness, indicated by a difference in thermal conductivity. In this regard, thermal conductivity is lesser on a rougher surface compared to thermal conductivity on a smoother surface. As a result, heat transfer can occur more effectively through the second layer of anisotropic material 58c compared to heat transfer through the first layer of anisotropic material 44c. This directs heat transfer to occur closest to the TIM and away from the TRB.

The first layer of anisotropic material 44c is configured to allow a first degree of heat transfer in a direction parallel to the first layer of anisotropic material 44c along the side wall 22 and to allow a second degree of heat transfer in directions transverse to the first layer of anisotropic material 44c along the side wall 22. In other words, the first layer of anisotropic material 44c directs heat along the side wall 22 toward the TIM and the cold plate for further dissipation away from the cells 14, and the first layer of anisotropic material 44a resists heat transfer from the side wall 22 of the enclosure 16 in directions toward adjacent cells 14.

Additionally, the second layer of anisotropic material 58c is configured to allow a third degree of heat transfer in a direction parallel to the second layer of anisotropic material 58c along the second end wall 20 and to allow a fourth degree of heat transfer in directions transverse to the second layer of anisotropic material 58c along the second end wall 20. In other words, the second layer of anisotropic material 58c directs heat along the second end wall 20 and along the TIM and the cold plate for further dissipation away from the cells 14. While the third degree of heat transfer is greater than the fourth degree of heat transfer, the positioning of the second layer of anisotropic material 58c against a large surface area of the TIM accommodates sufficient transfer of heat through the second layer of anisotropic material 58c into the TIM. In other words, heat spreads quickly at the third degree of heat transfer to spread heat across a large surface area of the TIM and enabling sufficient heat transfer into the TIM. Additionally, the third degree of heat transfer is greater than the first degree of heat transfer, and the fourth degree of heat transfer is greater than the second degree of heat transfer. This is due to the first layer of anisotropic material 44c having the first surface roughness that is greater than the second surface roughness of the second layer of anisotropic material 58c.

Put another way, the first layer of anisotropic material 44c has a first level of thermal conductivity 50c extending in the direction parallel to the side wall 22. Additionally, the first layer of anisotropic material 44c has a second level of thermal conductivity 52c extending in a direction transverse to the side wall 22. In reference to FIGS. 5A and 5B, the first level of thermal conductivity 50c is represented by the arrow pointing in the direction parallel to the side wall 22 and the second level of thermal conductivity 52c is represented by the arrow pointing perpendicular to the side wall 22. In other examples, the first layer of anisotropic material 44c may resist and direct the transfer of heat to varying degrees in any suitable direction relative to the walls of the enclosure 16. In the illustrated example, the first level of thermal conductivity 50c is greater than the second level of thermal conductivity 52c. In other words, heat transfer occurs more efficiently and quicker in the direction parallel to the side wall 22 compared to the direction transverse to the side wall 22.

The second layer of anisotropic material 58c has a third level of thermal conductivity 54c extending in the direction parallel to the second end wall 20. Additionally, the second layer of anisotropic material 58c has a fourth level of thermal conductivity 56c extending in a direction transverse to the second end wall 20. The third level of thermal conductivity 54c is represented by the arrow pointing in the direction parallel to the second end wall 20 and the fourth level of thermal conductivity 56c is represented by the arrow pointing perpendicular to the second end wall 20. In other examples, the second layer of anisotropic material 58c may resist and direct the transfer of heat to varying degrees in any suitable direction relative to the walls of the enclosure 16. In the illustrated example, the third level of thermal conductivity 54c is greater than the fourth level of thermal conductivity 56c. In other words, heat transfer occurs more efficiently and quicker in the direction parallel to the second end wall 20 compared to the direction transverse to the second end wall 20. However, heat spreads quickly across a large surface area of the TIM, enabling sufficient heat transfer along the second layer of anisotropic material 58c and into the TIM. The third level of thermal conductivity 54c is greater than the first level of thermal conductivity 50c, while the fourth level of thermal conductivity 56c is greater than the second level of thermal conductivity 52c.

During operation of the prismatic battery assembly 12c, heat generated within the battery cell 14 transfers through the side wall 22 and the second end wall 20 and eventually reaches the first layer of anisotropic material 44c. The first level of thermal conductivity 50c enables quick and efficient transfer of heat through the first layer of anisotropic material 44c in the direction parallel to the side wall 22 from the first end wall of the enclosure 16 toward the second end wall 20 of the enclosure 16. The second level of thermal conductivity 52c resists transfer of heat through the first layer of anisotropic material 44c in the direction transverse to the side wall 22. Furthermore, the third level of thermal conductivity 54c enables quick and efficient transfer of heat through the second layer of anisotropic material 58c in the direction parallel to the second end wall 20. The fourth level of thermal conductivity 56c resists transfer of heat through the second layer of anisotropic material 58c in the direction transverse to the second end wall 20. However, heat may spread across a large surface area of the TIM to transfer into the TIM. In this regard, heat may travel out of the battery cell 14, into the layers of anisotropic material 44c, 58c and toward the TIM and the cold plate. Due to the second level of thermal conductivity 52c being much lower than the first level of thermal conductivity 50c, heat transfer is resisted through the first layer of anisotropic material 44a in directions transverse to the side wall 22. In this regard, heat is generally prevented from traveling into the TRB, as the vast majority of generated heat travels into the TIM and the cold plate.

Furthermore, the prismatic battery assembly 12c includes a layer of polypropylene (PP) 46 and a layer of polyethylene terephthalate (PET) 48. The layer of PP 46 is disposed at the interior surface 34 of the side wall 22 and the interior surface 30 of the second end wall 20 of the enclosure 16. The layer of PET 48 is disposed at the exterior surface 36 of the side wall 22 and the exterior surface 32 of the second end wall 20 of the enclosure 16. The layer of PP 46 behaves as an electrically insulating material and is configured to isolate the components contained within the battery cell 14, such as the electrode stack, from the enclosure 16. In a similar manner, the layer of PET 48 is configured to electrically insulate the battery cell 14, but also provides mechanical structure and chemical stability to the battery cell 14. In this configuration, the layer of PET 48 is disposed between the enclosure 16 and the layers of anisotropic material 44c, 58c.

In some examples, the prismatic battery assembly includes layers of anisotropic material disposed between the enclosure and the layer of PET. For example, and with particular reference to FIG. 6, a prismatic battery assembly 12d includes a first layer of anisotropic material disposed between the side wall and the layer of PET, as well as a second layer of anisotropic material disposed between the second end wall and the layer of PET. In view of the substantial similarity in structure and function of the components associated with the prismatic battery assembly 12, like reference numerals are used hereinafter and in the drawings to identify like components while like reference numerals containing letter and number extensions are used to identify those components that have been modified.

The prismatic battery assembly 12d includes an enclosure 16 formed from a steel or a steel-alloy material and that includes a first end wall and a second end wall 20 opposite the first end wall. The enclosure 16 also includes one or more side walls 22 that extends between the first end wall and the second end wall 20. The first end wall of the enclosure 16 includes an interior surface and an exterior surface opposite the interior surface. The interior surface of the first end wall may interface with the electrode stack of the battery cell 14, while the exterior surface of the first end wall faces external of the battery cell 14. Likewise, the second end wall 20 of the enclosure 16 includes an interior surface 30 and an exterior surface 32 opposite the interior surface 30. The interior surface 30 of the second end wall 20 interfaces with the battery cell 14, while the exterior surface 32 of the second end wall 20 faces external of the battery cell 14. In a similar manner, the side wall 22 includes an interior surface 34 and an exterior surface 36 opposite the interior surface 34. The interior surface 34 of the side wall 22 interfaces with the electrode stack of the battery cell 14, while the exterior surface 36 of the side wall 22 faces external of the battery cell 14.

A thermal interface material (TIM) is disposed below the cells 14 of the prismatic battery assembly 12d and thermally conductively connects the cells 14 to a heat dissipating element or cold plate for regulating temperature of the prismatic battery assembly 12d. For example, the TIM may interface with the exterior surface 32 of the second end walls 20 of the battery cells 14 and be disposed between the cold plate and the cells 14. The TIM and the cold plate may cooperatively act as a heat sink or a heat spreader to enable efficient thermal transfer from the battery cell 14 during its operation.

A thermal runaway barrier (TRB) is disposed between the exterior surface 36 of the side wall 22 of the enclosure 16 and an adjacent battery cell 14. In other words, the TRB acts as a barrier between each battery cell 14 to limit the transfer of heat between the battery cells 14. In this regard, the TRB helps to reduce the potential of a thermal runaway event from spreading between cells 14 of the prismatic battery assembly 12d.

The prismatic battery assembly 12d includes a first layer of anisotropic material 44d disposed at the exterior surface 36 of the side wall 22 and extending in a direction parallel to the side wall 22. Furthermore, a second layer of anisotropic material 58d is disposed at the exterior surface 32 of the second end wall 20 and extends in a direction parallel to the second end wall 20. In other words, the first layer of anisotropic material 44d is positioned between the exterior surface 36 of the side wall 22 and the TRB, and the second layer of anisotropic material 58d is positioned between the exterior surface 32 of the second end wall 20 and the TIM. The layers of anisotropic material 44d, 58d include graphite and are configured to dissipate heat that is generated within the battery cell 14. For example, heat generated within the enclosure 16 is dissipated at least partially through the side wall 22 and into the first layer of anisotropic material 44d. Additionally, heat generated within the enclosure 16 is dissipated at least partially through the second end wall 20 and into the second layer of anisotropic material 58d. The second layer of anisotropic material 58d may extend beneath one or more of the cells 14 of the prismatic battery assembly 12d to evenly distribute heat generated by the cells 14 across the TIM.

The first layer of anisotropic material 44d is configured to allow a first degree of heat transfer in a direction parallel to the first layer of anisotropic material 44d along the side wall 22 and to allow a second degree of heat transfer in directions transverse to the first layer of anisotropic material 44d along the side wall 22. In other words, the first layer of anisotropic material 44d directs heat along the side wall 22 toward the TIM and the cold plate for further dissipation away from the cells 14, and the first layer of anisotropic material 44d resists heat transfer from the side wall 22 of the enclosure 16 in directions toward adjacent cells 14.

Additionally, the second layer of anisotropic material 58d is configured to allow a third degree of heat transfer in a direction parallel to the second layer of anisotropic material 58d along the second end wall 20 and to allow a fourth degree of heat transfer in directions transverse to the second layer of anisotropic material 58d along the second end wall 20. In other words, the second layer of anisotropic material 58d directs heat along the second end wall 20 and along the TIM and the cold plate for further dissipation away from the cells 14. While the third degree of heat transfer is greater than the fourth degree of heat transfer, the positioning of the second layer of anisotropic material 58d against a large surface area of the TIM accommodates sufficient transfer of heat through the second layer of anisotropic material 58d into the TIM. In other words, heat spreads quickly at the third degree of heat transfer to spread heat across a large surface area of the TIM and enabling sufficient heat transfer into the TIM.

Put another way, the first layer of anisotropic material 44d has a first level of thermal conductivity 50d extending in the direction parallel to the side wall 22. Additionally, the first layer of anisotropic material 44d has a second level of thermal conductivity 52d extending in a direction transverse to the side wall 22. In reference to FIG. 6, the first level of thermal conductivity 50d is represented by the arrow pointing in the direction parallel to the side wall 22 and the second level of thermal conductivity 52d is represented by the arrow pointing perpendicular to the side wall 22. In other examples, the first layer of anisotropic material 44d may resist and direct the transfer of heat to varying degrees in any suitable direction relative to the walls of the enclosure 16. In the illustrated example, the first level of thermal conductivity 50d is greater than the second level of thermal conductivity 52d. In other words, heat transfer occurs more efficiently and quicker in the direction parallel to the side wall 22 compared to the direction transverse to the side wall 22. For example, first level of thermal conductivity 50d may be at or near 1800 Watts per meters-Kelvin (W/mK), while the second level of thermal conductivity 52d may be at or near 15 W/mK.

The second layer of anisotropic material 58d has a third level of thermal conductivity 54d extending in the direction parallel to the second end wall 20. Additionally, the second layer of anisotropic material 58d has a fourth level of thermal conductivity 56d extending in a direction transverse to the second end wall 20. The third level of thermal conductivity 54d is represented by the arrow pointing in the direction parallel to the second end wall 20 and the fourth level of thermal conductivity 56d is represented by the arrow pointing perpendicular to the second end wall 20. In other examples, the second layer of anisotropic material 58d may resist and direct the transfer of heat to varying degrees in any suitable direction relative to the walls of the enclosure 16. In the illustrated example, the third level of thermal conductivity 54d is greater than the fourth level of thermal conductivity 56d. In other words, heat transfer occurs more efficiently and quicker in the direction parallel to the second end wall 20 compared to the direction transverse to the second end wall 20. However, heat spreads quickly across a large surface area of the TIM, enabling sufficient heat transfer along the second layer of anisotropic material 58d and into the TIM. The third level of thermal conductivity 54d may be at or near 1800 W/mK, while the fourth level of thermal conductivity 56d may be at or near 15 W/mK.

During operation of the prismatic battery assembly 12d, heat generated within the battery cell 14 transfers through the side wall 22 and the second end wall 20 and eventually reaches the first layer of anisotropic material 44d. The first level of thermal conductivity 50d enables quick and efficient transfer of heat through the first layer of anisotropic material 44d in the direction parallel to the side wall 22 from the first end wall of the enclosure 16 toward the second end wall 20 of the enclosure 16. The second level of thermal conductivity 52d resists transfer of heat through the first layer of anisotropic material 44d in the direction transverse to the side wall 22. Furthermore, the third level of thermal conductivity 54d enables quick and efficient transfer of heat through the second layer of anisotropic material 58d in the direction parallel to the second end wall 20. The fourth level of thermal conductivity 56d resists transfer of heat through the second layer of anisotropic material 44d in the direction transverse to the second end wall 20. However, heat is enabled to quickly spread across a large surface area of the TIM and can effectively transfer into the TIM. In this regard, heat is enabled to travel out of the battery cell 14, into the layers of anisotropic material 44d, 58d, and toward the TIM and the cold plate. Due to the second level of thermal conductivity 52d being much lower than the first level of thermal conductivity 50d, heat transfer is resisted through the first layer of anisotropic material 44d in the direction transverse to the side wall 22. In this regard, heat is generally prevented from traveling into the TRB, as the vast majority of generated heat travels into the TIM and the cold plate.

Furthermore, the prismatic battery assembly 12d includes a layer of polyethylene terephthalate (PET) 48d. The layer of PET 48d is disposed at the exterior surface 36 of the side wall 22 and the exterior surface 32 of the second end wall 20 of the enclosure 16. The layer of PET 48d is configured to electrically insulate the battery cell 14, but also provides mechanical structure and chemical stability to the battery cell 14. In this configuration, the layers of anisotropic material 44d, 58d are disposed between the enclosure 16 and the layer of PET 48d.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A prismatic battery assembly comprising:
a cell including an enclosure having a first end, a second end, a side wall extending between the first end and the second end, and a terminal disposed at the first end;
a heat dissipating element extending along the second end;
a layer of anisotropic material extending in a direction parallel to the side wall, the anisotropic material having a first level of thermal conductivity in the direction parallel to the side wall and a second level of thermal conductivity in a direction transverse to the side wall, the first level of thermal conductivity greater than the second level of thermal conductivity; and
wherein, during operation of the prismatic battery assembly, heat generated within the enclosure of the cell is dissipated along the layer of anisotropic material in the direction parallel to the side wall and into the heat dissipating element.

2. The prismatic battery assembly of claim 1, wherein the layer of anisotropic material extends along an exterior surface of the side wall.

3. The prismatic battery assembly of claim 1, wherein the layer of anisotropic material extends along an interior surface of the side wall.

4. The prismatic battery assembly of claim 3, wherein at least one layer of electrically insulating material extends along the layer of anisotropic material.

5. The prismatic battery assembly of claim 1, wherein another layer of anisotropic material extends along the second end of the enclosure.

6. The prismatic battery assembly of claim 5, wherein the other layer of anisotropic material extends along an exterior surface of the second end of the enclosure.

7. The prismatic battery assembly of claim 6, wherein the layer of anisotropic material has a first surface roughness and the other layer of anisotropic material has a second surface roughness, the first surface roughness being greater than the second surface roughness.

8. The prismatic battery assembly of claim 5, wherein the other layer of anisotropic material extends along an interior surface of the second end of the enclosure.

9. The prismatic battery assembly of claim 1, wherein the layer of anisotropic material includes a polyethylene terephthalate (PET) substrate.

10. The prismatic battery assembly of claim 1, wherein the layer of anisotropic material includes graphite.

11. A cell for a prismatic battery assembly, the cell comprising:
an enclosure including:
a first end,
a second end, wherein a heat dissipating element extends along the second end,
a side wall extending between the first end and the second end, wherein a layer of anisotropic material extends in a direction parallel to the side wall, the anisotropic material having a first level of thermal conductivity in the direction parallel to the side wall and a second level of thermal conductivity in a direction transverse to the side wall, the first level of thermal conductivity greater than the second level of thermal conductivity, and
a terminal disposed at the first end; and
wherein, during operation of the prismatic battery assembly, heat generated within the enclosure of the cell is dissipated along the layer of anisotropic material in the direction parallel to the side wall and into the heat dissipating element.

12. The cell of claim 11, wherein the layer of anisotropic material extends along an exterior surface of the side wall.

13. The cell of claim 11, wherein the layer of anisotropic material extends along an interior surface of the side wall.

14. The cell of claim 11, wherein another layer of anisotropic material extends along the second end of the enclosure.

15. The cell of claim 11, wherein the layer of anisotropic material includes at least one from the group consisting of i) graphite, and ii) a polyethylene terephthalate (PET) substrate.

16. A vehicle comprising:
a prismatic battery assembly including:
a cell including an enclosure having a first end, a second end, a side wall extending between the first end and the second end, and a terminal disposed at the first end;
a heat dissipating element extending along the second end;
a layer of anisotropic material extending in a direction parallel to the side wall, the anisotropic material having a first level of thermal conductivity in the direction parallel to the side wall and a second level of thermal conductivity in a direction transverse to the side wall, the first level of thermal conductivity greater than the second level of thermal conductivity; and
wherein, during operation of the prismatic battery assembly, heat generated within the enclosure of the cell is dissipated along the layer of anisotropic material in the direction parallel to the side wall and into the heat dissipating element.

17. The vehicle of claim 16, wherein the layer of anisotropic material extends along an exterior surface of the side wall.

18. The vehicle of claim 16, wherein the layer of anisotropic material extends along an interior surface of the side wall.

19. The vehicle of claim 16, wherein another layer of anisotropic material extends along the second end of the enclosure.

20. The vehicle of claim 16, wherein the layer of anisotropic material includes at least one from the group consisting of i) graphite, and ii) a polyethylene terephthalate (PET) substrate.
